(19) United States
(12) Patent Application Publication
(10) Pub. No.: US 2005/0011566 A1
(43) Pub. Date: Jan. 20, 2005

(54) Hydraulic pipe sleeve

(76) Inventor: Blake Schritter, Kingman, AZ (US)

Correspondence Address: LITMAN LAW OFFICES, LTD., P.O. BOX 15035 CRYSTAL CITY STATION, ARLINGTON, VA, 22215, US

(21) Appl. No.: 10/618,307

(22) Filed: Jul. 14, 2003

(51) Int. Cl. F16L 11/00

(52) U.S. Cl. 138/96 R; 138/110; 138/109

(57) ABSTRACT

An elastic sleeve is effective to cover and seal the temporarily open end of a hydraulic pipe or the like. The sleeve is preferably fabricated from latex material. A high degree of elasticity allows the sleeve to tightly conform to the configuration and seal the open end of virtually any pipe. This seal will allow components of hydraulic lines to be repaired and cleaned while preventing fluid leakage and debris entry.

### BACKGROUND OF THE INVENTION

1. Field of the Invention

The present invention generally relates to sealing members. More specifically, the present invention is drawn to an elastic sleeve for sealing the outlet of an open hydraulic pipe.

2. Description of the Related Art

It is sometimes necessary to open hydraulic lines for cleaning and repairing. In such instances fluid may leak from the open lines and/or debris can enter the line, creating future problems. A solution of course, would be to cap the open line thereby preventing leakage and/or the egress of debris. Hereto fore the prior art caps employed for such purposes have been relatively cumbersome to use and expensive to make. The prior art would certainly welcome a cap for sealing the open end of pipes, which cap is easy to use and inexpensive to manufacture.

Examples of the aforementioned prior art caps include those disclosed in U.S. Pat. Nos. 4,300,597 (Delay, Sr.), 4,481,977 (Maldavs) 5,337,792 (Tempel), 5,775,375 (Calhoun), 6,050,613 (Wartluft) and 6,170,529 B1 (Howe).

U.S. Pat. No. 6,032,697 (Kennedy) discloses a standpipe cover that comprises a brightly colored plastic sheet. The sheet requires drawstrings for closure. It is apparent that the drawstrings could easily loosen to provide a breach in the closure.

UK Patent No. 2,238,303 is drawn to a latex lid for a beverage cup or the like. The lid is semi-rigid and is fabricated by an expensive molding process.

None of the above inventions and patents, taken either singly or in combination, is seen to disclose a flexible elastic hydraulic pipe cover as will subsequently be described and claimed in the instant invention.

### SUMMARY OF THE INVENTION

The present invention is an elastic sleeve effective to cover and seal the temporarily open end of a hydraulic pipe or the like. The sleeve is preferably fabricated from latex material. A high degree of elasticity allows the sleeve to tightly conform to the configuration and to seal the open end of virtually any pipe. This seal will allow components of hydraulic lines to be repaired and cleaned while preventing fluid leakage and debris entry.

As contemplated, the sleeve will be fabricated in four sizes (½″, 1″ ½″ and 2″) so as to fit the most commonly employed hydraulic pipes. It is obvious, however that the sleeve could be made to fit atypical pipes, if desired.

Accordingly, it is a principal object of the invention to provide a sleeve for sealing the open end of a hydraulic pipe.

It is another object of the invention to provide a sleeve for sealing the open end of a hydraulic pipe, which sleeve is elastic and will conform to the open end of the pipe.

It is a further object of the invention to provide a sleeve for sealing the open end of a hydraulic pipe, which sleeve can be quickly and easily installed and removed.

Still another object of the invention is to provide a sleeve for sealing the open end of a hydraulic pipe, which sleeve is easy to manufacture.

It is an object of the invention to provide improved elements and arrangements thereof for the purposes described which are inexpensive, dependable and fully effective in accomplishing their intended purposes.

These and other objects of the present invention will become readily apparent upon further review of the following specification and drawings.

### BRIEF DESCRIPTION OF THE DRAWINGS

FIG. 1 is an environmental view of an elastic sleeve for a hydraulic pipe according to the present invention.

FIG. 2 is an exploded, environmental view of an elastic sleeve for a hydraulic pipe according to the present invention.

FIG. 3 is a plan view of an elastic sleeve for a hydraulic pipe according to the present invention

Similar reference characters denote corresponding features consistently throughout the attached drawings.

### DETAILED DESCRIPTION OF THE PREFERRED EMBODIMENT

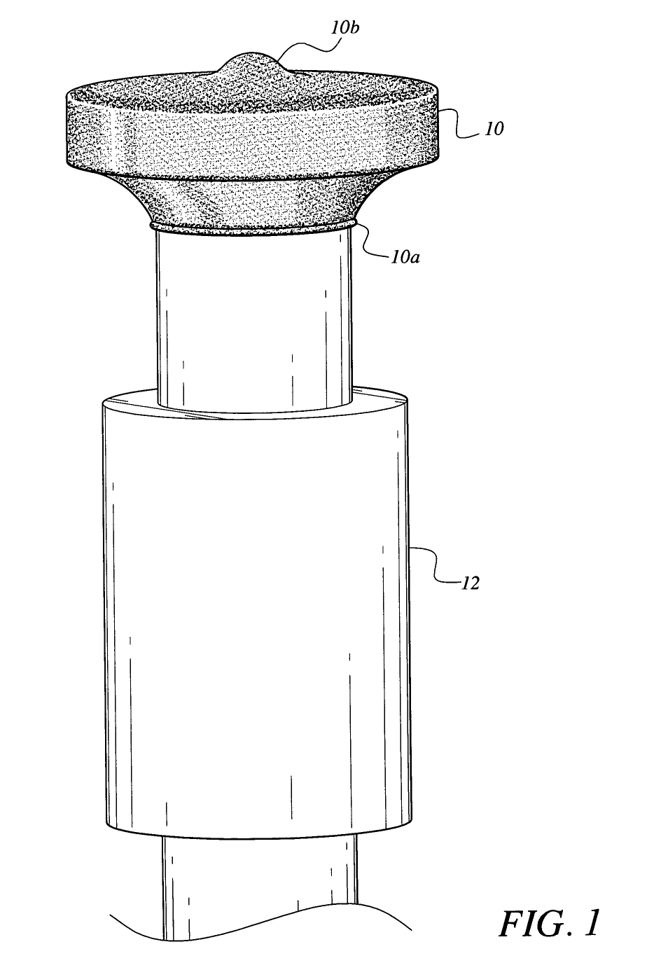

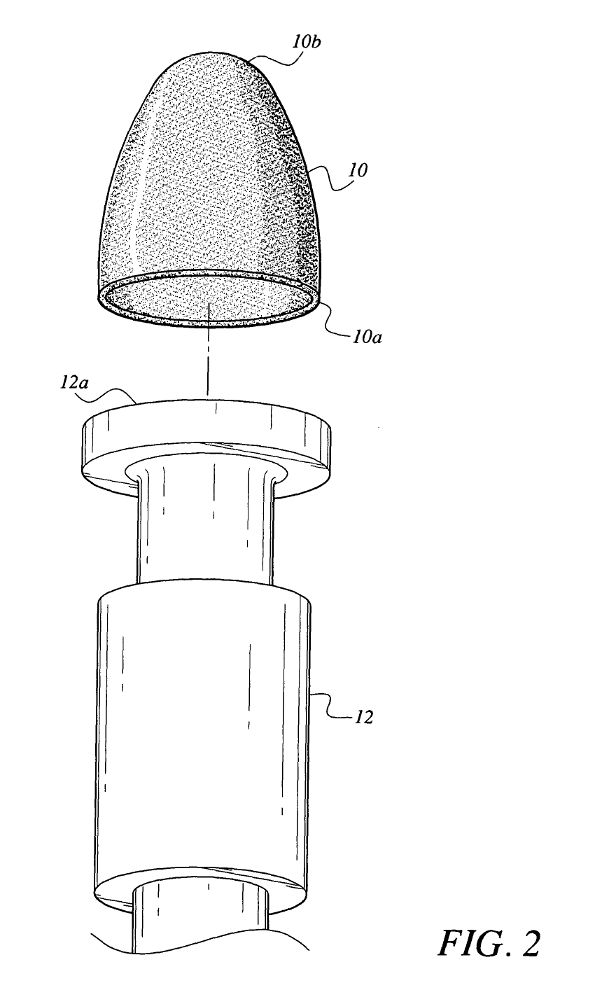

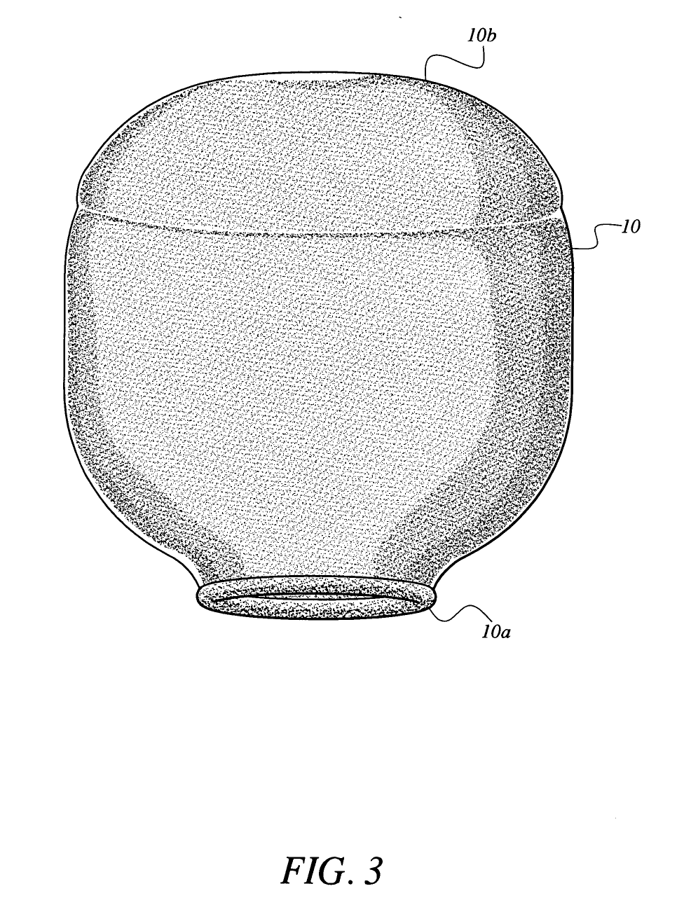

Attention is directed to FIGS. 1-3 wherein the sleeve of the present invention is indicated at 10. Sleeve 10 is adapted to cover and seal the open end 12a of a hydraulic pipe 12. As pointed out above, pipe 12 may need to be opened for any number of reasons, such as routine maintenance, repair, cleaning, etc. Sleeve 10 is utilized to cover and seal the open end to prevent unwanted leakage from the pipe 12 and/or the egress of debris into the pipe 12.

Sleeve 10 consists of a one-piece elastic body having an open bottom and a closed top portion. The open bottom is provided with a rolled ribbed part 10a. The closed top includes a reinforced portion 10b. As illustrated, sleeve 10 will easily adapt to the contour of the pipe 12. Ribbed part 10a will produce a strong, positive gripping force so that the sleeve 10 will remain in place on the pipe 12. Reinforced top 10b provides extra strength to prevent the sleeve 10 from easily rupturing if accidentally contacted by foreign matter or the like. As noted above, the sleeve 10 may come in a variety of standard sizes to accommodate conventional hydraulic pipes. A number of sleeves 10 can be conveniently carried in a tool kit to be available for use when needed. A sleeve 10 can be quickly and easily installed and removed from the end of a pipe 12 without expending much time or effort.

The sleeve 10 is preferably made from latex.

It is to be understood that the present invention is not limited to the embodiment described above, but encompasses any and all embodiments within the scope of the following claims.

1-6. (Cancelled)

7. A sleeve in combination with a hydraulic pipe, comprising:
a pipe adapted for serving as a conduit for fluid, the pipe having an open end;
a one-piece body fabricated from latex, said one-piece body having an open bottom and a closed top and being removably disposed on the open end of said pipe in order to seal said open end, thereby preventing leakage of hydraulic fluid from said open end and the ingress of debris into said open end;
a ribbed portion disposed around and defining said open bottom; and
a reinforced portion defining said closed top, whereby said sleeve is strengthened at said top and prevented from easily rupturing.
